(19) United States
(12) Patent Application Publication
(10) Pub. No.: US 2015/0360651 A1
(43) Pub. Date: Dec. 17, 2015

(54) INTEGRATION OF A RADAR SENSOR IN A VEHICLE

(71) Applicant: Continental Automotive Systems, Inc., Auburn Hills, MI (US)

(72) Inventors: Michael J Zaitz, Royal Oak, MI (US); Nicholas M Pinazzo, Madison Heights, MI (US); Andrew M Haig, Birmingham, MI (US)

(21) Appl. No.: 14/304,178

(22) Filed: Jun. 13, 2014

(51) Int. Cl. B60S 1/48

(52) U.S. Cl. CPC B60S 1/481

(57) ABSTRACT

A washer system includes a washer pump constructed and arranged to pump washer fluid from a reservoir to an outlet of the pump. The pump includes an inlet port extending from a bottom thereof. The pump also includes surface features associated with the bottom thereof. Grommet structure has first and second ends and a fluid passage between the ends. The inlet port is received in the fluid passage. The grommet structure has surface features that mate with the surface features of the pump so as to prevent the pump from rotating with respect to the grommet structure.

### FIELD

This invention relates to vehicle windshield washer systems and, more particularly, to a grommet structure that prevents a washer pump from rotating.

### BACKGROUND

A conventional washer pump for discharging a window washer fluid to a vehicle's windshield or headlight typically includes a motor and a pump that is driven by the motor. An inlet port of the pump is connected to a fluid reservoir via a grommet, and washer fluid in the reservoir is sucked in from the inlet port due to the operation of the pump and is discharged from an outlet of the pump. The inlet port is permitted to rotate within the grommet. Such rotation may cause broken inlet ports on washer pumps and washer fluid may leak at the interface of the pump and grommet.

Thus, there is a need to prevent rotation of a washer pump relative to a grommet to reduce damage to pump inlet ports and to minimize leaks.

### SUMMARY

An objective of the invention is to fulfill the need referred to above. In accordance with the principles of an embodiment, this objective is achieved by a washer system that includes a washer pump constructed and arranged to pump washer fluid from a reservoir to an outlet of the pump. The pump includes an inlet port extending from a bottom thereof. The pump also includes surface features associated with the bottom thereof. Grommet structure has first and second ends and a fluid passage between the ends. The inlet port is received in the fluid passage. The grommet structure has surface features that mate with the surface features of the pump so as to prevent the pump from rotating with respect to the grommet structure.

In accordance with another aspect of an embodiment, a method prevents rotation of a washer pump. The method provides a washer pump including surface features associated with the bottom thereof. A grommet structure is provided and has surface features that mate with the surface features of the pump. The grommet structure is coupled to the pump by engaging the surface features of the grommet structure with the surface features of the pump and thereby preventing rotation of the pump with respect to the grommet structure.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is an exploded view of a washer system showing a grommet structure, in accordance with an embodiment, ready to be coupled with an inlet port of a washer pump.

FIG. 2 a perspective view the washer system of FIG. 1, showing the grommet structure coupled with the washer pump.

FIG. 3 is an enlarged top view of the grommet structure of FIG. 1.

FIG. 4 is an enlarged top perspective view of the grommet structure of FIG. 1.

### DETAILED DESCRIPTION OF EXEMPLARY EMBODIMENTS

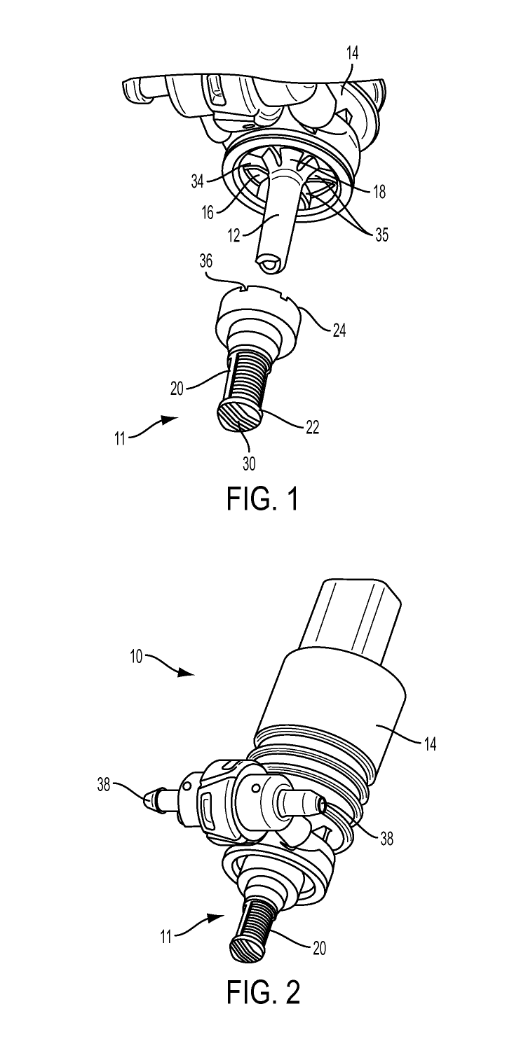

With reference to FIGS. 1 and 2, a washer system is shown, generally indicated at 10. The washer system 10 is for delivering washer fluid to a windshield or headlights of a vehicle. As shown in FIG. 1, the washer system 10 includes a grommet structure, generally indicated at 11, ready to be coupled to an inlet port 12 of a vehicle washer pump 14. The inlet port 12 is in the form of a generally cylindrical tube or nipple that extends from a bottom surface 16 of the pump 14. The nipple 12 includes a generally tapered or conical portion 18 at the interface with the bottom surface 16 of the pump 14, the function of which will be explained below.

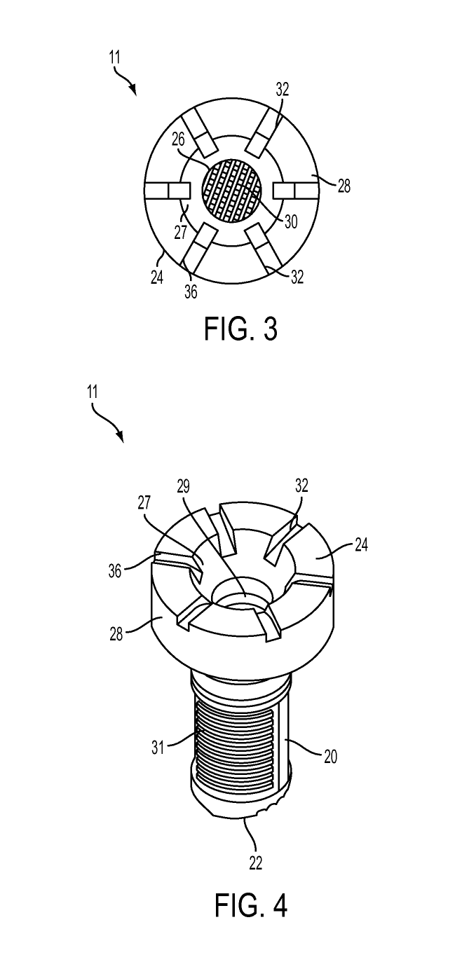

As best shown in FIGS. 3-4, the grommet structure 11 includes a body 20 having a first end 22 and an opposing second end 24 and a fluid passage 26 communicating between the ends 22, 24. Second end 24 is defined by a flange 28. The fluid passage 26 includes a conical surface 27, in the flange 28, for receiving conical portion 18 of the nipple 12. A remaining portion 29 of the fluid passage is cylindrical so as to receive the cylindrical portion the nipple 12. The first end 22 includes an integral filter 30 that prevents foreign particles from being sucked into the pump 12 as explained below. A portion 31 of the body 20 can also include a filter. The flange 28 includes surface features 32 that engage with the surface features 34 of the pump 14 to prevent rotation of the pump 14 relative to the grommet structure 11.

With reference to FIG. 1, in the embodiment, the surface features 34 of the pump include protrusions 35 extending from the bottom surface 16 of the pump 12 and the surface features 32 of the grommet structure 11 include mating recesses 36 in the end 24 of the flange 28, with each recess 36 receiving an associated protrusion 35. The protrusions 35 are spaced generally evenly about the nipple 12 and the recesses 36 are spaced generally evenly about the periphery of the end 24 of the grommet structure so as to align with the protrusions 35. It can be appreciated that instead of providing recesses 36 in the flange 28 of the grommet structure 11 and protrusions 35 on the pump 14, the recesses can be provided in a surface of the pump 14 with the protrusions being provided on the flange 28. In the embodiment, the protrusions 35 and the recesses 36 are each generally rectangular, forming a keyway feature, but other mating shapes could be employed. Thus, surfaces defining the recesses 36 engage the protrusions 35 to prevent rotation of the pump 12 with respect to the grommet structure 11.

Thus, when the grommet structure 11 is coupled with the pump 14 as shown in FIG. 2, the nipple 12 is disposed in the fluid passage 26. The first end 22 of the grommet structure 11 is then inserted into a fluid reservoir (not shown) of the vehicle and when the pump 14 is activated, the pump sucks washer fluid from the reservoir, through the filter 30, through the nipple 12, to deliver the washer fluid to the outlets 38 of the pump 14. The mating protrusions 35 and recesses 36 maintain the orientation of the pump 14 nested inside of the reservoir, thus reducing the amount of broken inlet ports 12 on pumps 14, and reducing washer fluid leakage at the interface of the washer pump 14 and grommet structure 11.

Another advantage of the embodiment is that the outlet(s) 38 of the pump 14 maintains an assembled position that allows consistent and easy access for the assembly of a hose to the pump on the automotive assembly line. If the outlet 38 is out of position (e.g., rotated), the operator has to adjust to proper position so the washer hose tube can be mated/assembled.

Since the grommet structure 11 and pump 14 are common on all washer systems, the mating keyway features discussed above can be used across the board on all washer systems.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A washer system comprising:
a washer pump constructed and arranged to pump washer fluid from a reservoir to an outlet of the pump, the pump including an inlet port extending from a bottom thereof, the pump also including surface features associated with the bottom thereof, and
grommet structure having first and second ends and a fluid passage between the ends, the inlet port being received in the fluid passage, the grommet structure having surface features that mate with the surface features of the pump so as to prevent the pump from rotating with respect to the grommet structure.

2. The system of claim 1, wherein the surface features of the pump include protrusions extending from a bottom surface of the pump and the surface features of the grommet structure include recesses in an end of the grommet structure, with a recess receiving an associated protrusion.

3. The system of claim 2, wherein the recesses and the protrusions are each generally rectangular.

4. The system of claim 2, wherein the protrusions are spaced generally evenly about the inlet port and the recesses are spaced generally evenly about the periphery of the second end of the grommet structure so as to align with the protrusions.

5. The system of claim 1, wherein the inlet port is a generally cylindrical nipple and the fluid passage includes a generally cylindrical portion that receives the nipple.

6. The system of claim 5, wherein an end of the nipple at an interface with the bottom of the pump includes a conical portion and the fluid passage includes a conical surface in the second end of the grommet structure for receiving the conical portion.

7. The system of claim 1, further comprising a filter at the first end of the grommet structure.

8. Grommet structure for coupling with a washer pump for pumping washer fluid from a reservoir to an outlet of the pump, the pump including an inlet port extending from a bottom thereof, the pump also including surface features associated with the bottom thereof, the grommet structure comprising:
a body having first and second ends and a fluid passage between the ends, the fluid passage being constructed and arranged to receive the inlet port, and
surface features associated with the body and constructed and arranged to mate with the surface features of the pump so as to prevent the pump from rotating with respect to the body.

9. The structure of claim 8, wherein the surface features of the pump include protrusions extending from a bottom surface of the pump and the surface features of the grommet structure include recesses in an end of the grommet structure, with a recess being constructed and arranged to receive an associated protrusion.

10. The structure of claim 9, wherein each recesses is generally rectangular.

11. The structure of claim 9, wherein the protrusions are spaced generally evenly about the inlet port and the recesses are spaced generally evenly about the periphery of the second end of the body so as to align with the protrusions.

12. The structure of claim 11, in combination with the washer pump.

13. The structure of claim 8, wherein the fluid passage includes a generally cylindrical portion.

14. The structure of claim 13, wherein fluid passage further includes a conical surface in the second end of the body.

15. The structure of claim 8, further comprising a filter at the first end of the body.

16. A method of preventing rotation of a washer pump comprising the steps of:
providing a washer pump including surface features associated with a bottom thereof,
providing grommet structure having surface features that mate with the surface features of the pump, and
coupling the grommet structure to the pump by engaging the surface features of the grommet structure with the surface features of the pump and thereby preventing rotation of the pump with respect to the grommet structure.

17. The method of claim 16, wherein the pump includes an inlet port extending from the bottom thereof, and the grommet structure has first and second ends and a fluid passage between the ends, wherein the coupling step includes receiving the inlet port in the fluid passage.

18. The method of claim 17, wherein the surface features of the pump include protrusions extending from the bottom surface of the pump and the surface features of the grommet structure include recesses in an end of the grommet structure, wherein the coupling step includes receiving a protrusion in an associated recess.

19. The method of claim 18, wherein the recesses and the protrusions are each generally rectangular.

20. The method of claim 18, wherein the protrusions are spaced generally evenly about the inlet port and the recesses are spaced generally evenly about the periphery of the second end of the grommet structure so as to align with the protrusions.
